(19) United States
(12) Patent Application Publication
(10) Pub. No.: US 2023/0407555 A1
(43) Pub. Date: Dec. 21, 2023

(54) Systems and Methods for Dieless Composite Forming

(71) Applicant: Northwestern University, Evanston, IL (US)

(72) Inventors: Sangram Keshari Rout, Los Angeles, CA (US); Jian Cao, Wilmette, IL (US); Marisa Ravena Bisram, Wilmette, IL (US)

(73) Assignee: Northwestern University, Evanston, IL (US)

(21) Appl. No.: 18/134,868

(22) Filed: Apr. 14, 2023

Related U.S. Application Data
(60) Provisional application No. 63/331,437, filed on Apr. 15, 2022.

(51) Int. Cl. D06M 10/00; D04B 1/16; D04B 1/22; H05B 3/34

(52) U.S. Cl. CPC D06M 10/00; H05B 3/345; D04B 1/225; D04B 1/16

(57) ABSTRACT

Knitmorphs and methods of knitmophing include knitting one or more yarn materials into knitted structure having a first shape. A thermal load may then be applied to all or part of the knitted structure to deform the knitted structure into a second shape. The thermal load can be removed to return the knitted structure to the first shape or a hardening agent can be applied to lock the knitted structure in the second shape.

### CROSS-REFERENCE TO RELATED APPLICATION

This application claims the benefit of U.S. Provisional Application No. 63/331,437, filed Apr. 15, 2023, which is hereby incorporated by reference in its entirety

### BACKGROUND

Shape morphing behavior has applications in many fields, and the most common approach to achieve shape morphing structures is through shape memory alloys or hydrogels. These materials undergo differential strains which generate a variety of shapes. New shape morphing techniques are needed to address other needs in various industries and fields.

It is with these concepts in mind, among others, that various aspects of the present disclosure were conceived.

### BRIEF SUMMARY OF THE INVENTION

This Summary provides an introduction to some general concepts relating to this invention in a simplified form that are further described below in the Detailed Description.

Aspects of the disclosure relate to methods of manufacturing a three-dimensional structure, the steps including obtaining a first yarn material, the first yarn material having first material properties; obtaining a second yarn material, the second yarn material having second material properties; knitting the first yarn material and the second yarn material together to form a knit structure having a first shape; and applying a thermal load to at least one of the first yarn material or the second yarn material to thereby deform the first yarn material and/or the second yarn material and thereby form a second shape.

The first yarn material and the second yarn material can be knitted together using purl stitches. The first yarn material and the second yarn material can be knitted together using plain stitches. The first yarn material and the second yarn material can also be braided together.

The thermal load can cause the first yarn material to expand. Or the thermal load can cause the first yarn material to contract.

The first yarn material can be a natural material. The first yarn material comprises one of wool, cashmere, alpaca, cotton, linen, or bamboo. The first yarn material can be a synthetic material. The first yarn material comprises one of rayon, acrylic, nylon, or polymer. The first yarn material comprises twisted and coiled nylon fibers.

The method can also include applying a resin to the three-dimensional shape to thereby lock the knitted structure in the second shape. In other examples, the method can include removing the thermal load to thereby return the knitted structure to the first shape.

Aspects of this disclosure also relate to a knit structure including a first yarn material, the first yarn material having first material properties; a second yarn material, the second yarn material having second material properties; wherein the first yarn material and the second yarn material are knit together forming a first shape; and wherein when a thermal load is applied to at least one of the first yarn material or the second yarn material the first yarn material and/or the second yarn material deform thereby form a second shape. The first yarn material and the second yarn material can be knitted together using purl stitches. In other examples the first yarn material and the second yarn material can be knitted together using plain stitches. In examples, the first yarn material and the second yarn material can be braided together.

In some examples a resin is applied to the knit structure. In other examples, when the thermal load is removed the knit structure returns to the first shape. In some examples, the first yarn material includes a heating wire integrated with the first yarn material.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. Also, in the drawings the like reference characters refer to the same parts throughout the different views. The drawings depict only typical embodiments of the present disclosure and, therefore, are not to be considered limiting in scope.

FIG. 1 shows a knit structure, according to aspects of the present disclosure.

FIG. 2A shows a plain knit structure comprised of knit stitches, according to aspects of the present disclosure.

FIG. 2B shows a close-up view of the knit structure of FIG. 2A.

FIG. 3A shows a rib knit structure comprised of alternating rows of knit and purl stitches, according to aspects of the present disclosure.

FIG. 3B shows a close-up view of the knit structure of FIG. 3A.

FIG. 4A shows a plain knit structure comprised of knit stitches and shows the locations of different knit materials, according to aspects of the present disclosure.

FIG. 4B shows the plain knit structure of FIG. 4A after a thermal load has been applied.

FIG. 5A shows a rib knit structure comprised of knit stitches adjacent to purl stitches and shows the locations of different knit materials, according to aspects of the present disclosure.

FIG. 5B show the rib knit structure of FIG. 5A after a thermal load has been applied.

FIG. 6A shows a knit structure, according to aspects of the present disclosure.

FIG. 6B shows a close-up view of a knit material of the knit structure of FIG. 6A.

FIG. 6C shows the locations of the different types of material included in the knit structure of FIG. 6A, according to aspects of the present disclosure.

FIG. 6D shows a morphed structure of FIG. 6A after exposing the knit structure to a thermal load.

FIG. 7A shows a knit structure, according to aspects of the present disclosure.

FIG. 7B shows a close-up view of the knit structure of FIG. 7A.

FIG. 7C shows the locations of the different types of material included in the knit structure of FIG. 7A, according to aspects of the present disclosure.

FIG. 7D shows a morphed structure of FIG. 7A after exposing the knit structure to a thermal load.

FIG. 8A shows a knit structure, according to aspects of the present disclosure.

FIG. 8B shows a close-up view of the knit structure of FIG. 8A.

FIG. 8C shows the locations of the different types of material included in the knit structure of FIG. 3A, according to aspects of the present disclosure.

FIG. 8D shows a morphed structure of FIG. 9A after exposing the knit structure to a thermal load.

FIG. 9A shows a knit structure, according to aspects of the present disclosure.

FIG. 9B shows a close-up view of the knit structure of FIG. 9A.

FIG. 9C shows the locations of the different types of material included in the knit structure of FIG. 9A, according to aspects of the present disclosure.

FIG. 9D shows a morphed structure of FIG. 9A after exposing the knit structure to a thermal load.

FIG. 10A shows a knit structure, according to aspects of the present disclosure.

FIG. 10B shows a close-up view of the knit structure of FIG. 10A.

FIG. 10C shows a front view of the knit structure of FIG. 10A.

FIG. 10D shows the locations of the different types of material included in the knit structure of FIG. 10D, according to aspects of the present disclosure.

FIG. 10E shows a morphed structure of FIG. 10E after exposing the knit structure to a thermal load.

FIG. 11A shows a coiled knit structure, according to aspects of the present disclosure.

FIG. 11B shows a morphed structure of FIG. 11A after exposing the knit structure to a thermal load.

FIG. 12A shows a knit structure, according to aspects of the present disclosure.

FIG. 12B shows a morphed structure of FIG. 12A after exposing the knit structure to a thermal load.

FIG. 13A shows a knit structure, according to aspects of the present disclosure.

FIG. 13B shows a morphed structure of FIG. 13A after exposing the knit structure to a thermal load.

FIG. 14A shows a knit structure, according to aspects of the present disclosure.

FIG. 14B shows a morphed structure of FIG. 14A after exposing the knit structure to a thermal load.

### DETAILED DESCRIPTION

While this invention is susceptible of embodiments in many different forms, there are shown in the drawings and will herein be described in detail example embodiments of the invention with the understanding that the present disclosure is to be considered as an exemplification of the principles of the invention and is not intended to limit the broad aspect of the invention to the embodiments illustrated. In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention.

Also, while the terms “top,” “bottom,” “front,” “back,” “side,” “distal,” and the like may be used in this specification to describe various example features and elements of the invention, these terms are used herein as a matter of convenience, e.g., based on the example orientations shown in the figures or the orientation during typical use. Nothing in this specification should be construed as requiring a specific three-dimensional orientation of structures in order to fall within the scope of this invention. Also, the reader is advised that the attached drawings are not necessarily drawn to scale.

Aspects of the present disclosure relate to shape morphing. And in particular, aspects of this disclosure relate to the novel concept that two-dimensional knits comprised of yarns from different materials can be morphed into different three-dimensional shapes particularly when the yarns are under certain thermal loads. This novel concept can form a bridge between traditional knitting and shape changing structures. This novel concept is referred to herein Knitmorphing and/or Knitmorphs. As described herein knitted patterns of varying materials can morph into complex shapes, such as saddle, axisymmetric cup, and a plate with waves when subjected to thermal loads. Applications for Knitmorphs or Knitmorphing can include programmable knits for developing robots based upon jellyfish like locomotion, and complex structures similar to wind turbine blades. Additional examples and details related to structures and methods are described herein.

As described herein utilization of materials having different coefficients of thermal expansion can be important to Knitmorphing. Selected materials can include high values of thermal coefficient of expansion and contraction along with have low stiffness to facilitate morphing. The materials will expand or contract due to the coefficients of thermal expansion for the materials and these can be designed to for a particular shape. In some embodiments, twisted and coiled nylon polymers (TCP) fibers can be used in knitmorphing.

As described herein a method of manufacturing a three-dimensional structure through knit morphing can include the steps of: obtaining a first yarn material, the first yarn material having first material properties; obtaining a second yarn material the second yarn material having second material properties; and knitting the first yarn material and the second yarn material together to form a knit structure. A thermal load then may be applied to at least one of the first yarn material or the second yarn material to thereby deform the first yarn material and/or the second yarn material. This may cause the knit structure to form a three-dimensional shape. The materials discussed herein may deform according to a linear thermal expansion model:

$${α}_{L} = \frac{1}{L} \frac{dL}{dT}$$

where L is the length measurement of the material and dL/dT is the rate of change of that linear dimension per unit change in temperature.

In some examples the first yarn material and the second yarn material may be the same yarn material or may be different yarn materials. Additionally, the same thermal load may be applied to the entire knit structure or different thermal loads may be applied to different portions of the knit structure.

A knit structure may include: a first yarn material the first yarn material having first material properties; and a second yarn material the second yarn material having second material properties. The first yarn material and the second yarn material may be knit together. As described above, a thermal load can be applied to at least one of the first yarn material or the second yarn material the first yarn material and/or the second yarn material can deform such that the knit structure forms a three-dimensional shape. As described above, in some examples the first yarn material and the second yarn material may be the same yarn material or may be different yarn materials. Additionally, the same thermal load may be applied to the entire knit structure or different thermal loads may be applied to different portions of the knit structure.

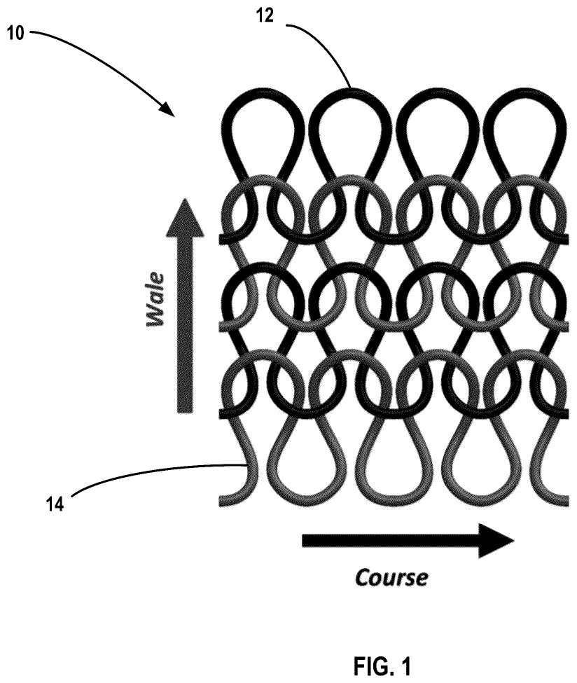

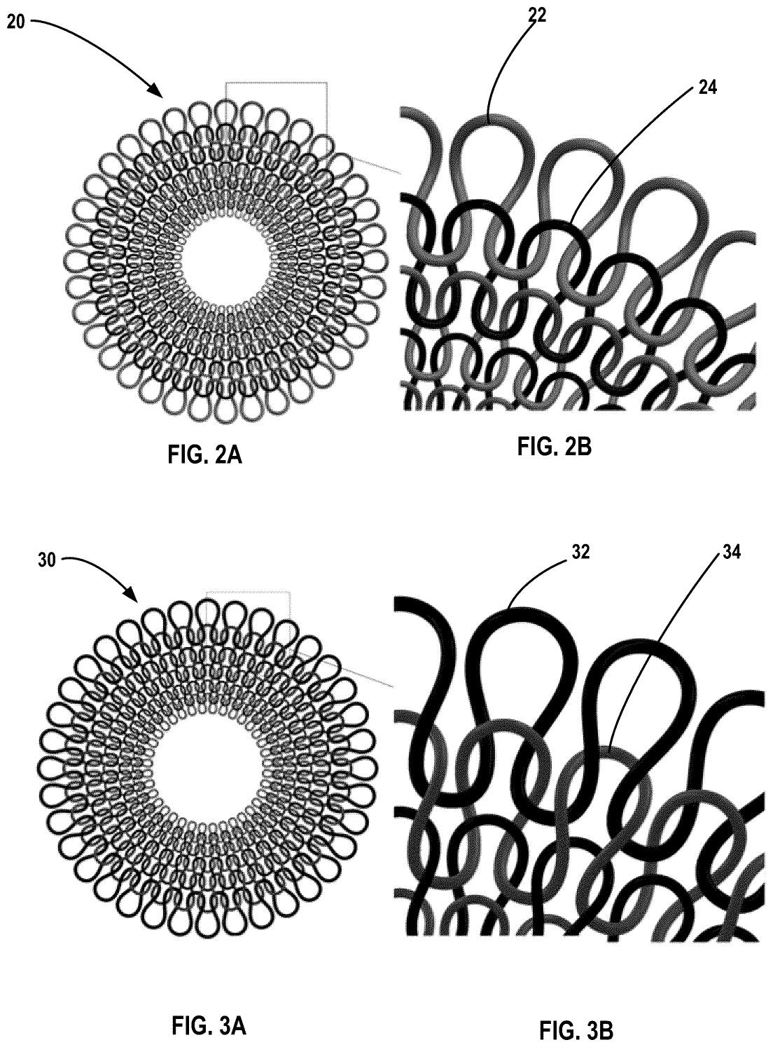

Referring now to FIG. 1 a knit structure is shown showing the wale and course directions of a knitted fabric comprised of a first knit material 12 and a second knit material 14. FIG. 2A shows a plain knit structure 20 comprised of a first knit material 22 and a second knit material 24 and wherein the structure is comprised of knit stitches. FIG. 3A shows a rib knit structure 30 comprised of a first knit material 32 and a second knit material 34 and wherein the structure is comprised of knit and purl stitches. While certain knit structures are shown and described herein any knitting pattern may be used to make any knit structure.

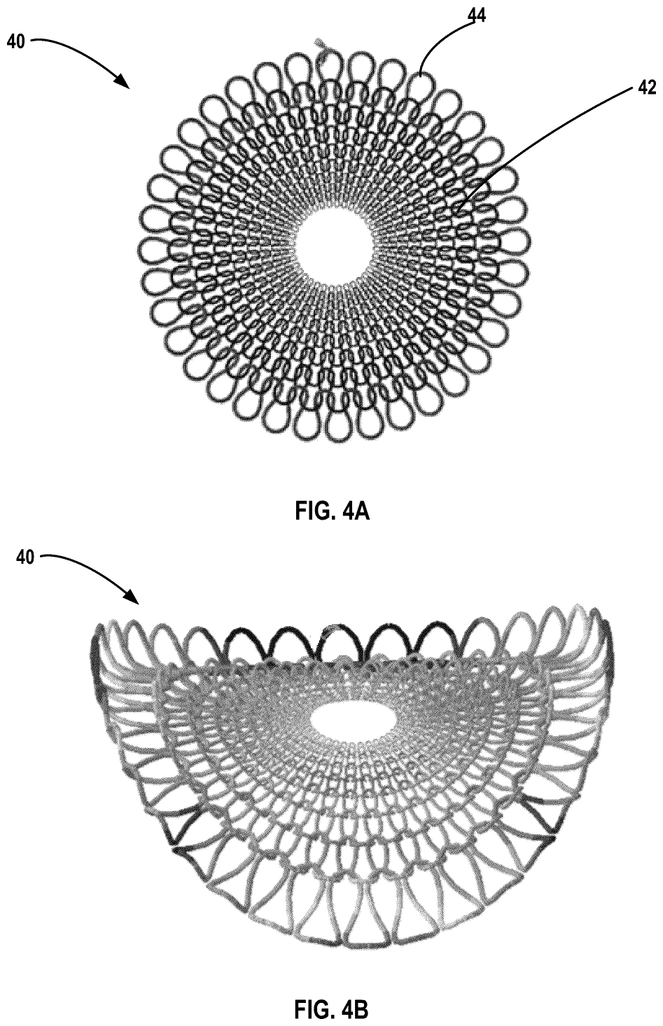

Referring now to FIG. 4A a plain knit structure 40 comprised of knit stitches is shown. The knit structure 40 is composed of a first knit material 42 and a second knit material 44 and each knit material has certain material characteristics shown below:

| | Thermal Coefficient | Elastic Modulus |
|---|---|---|
| First Knit Material 42 | −0.0005 | 2100 |
| Second Knit Material 44 | 0.0005 | 2100 |

FIG. 4B shows the knit structure 40 after a thermal load has been applied to the knit structure 40.

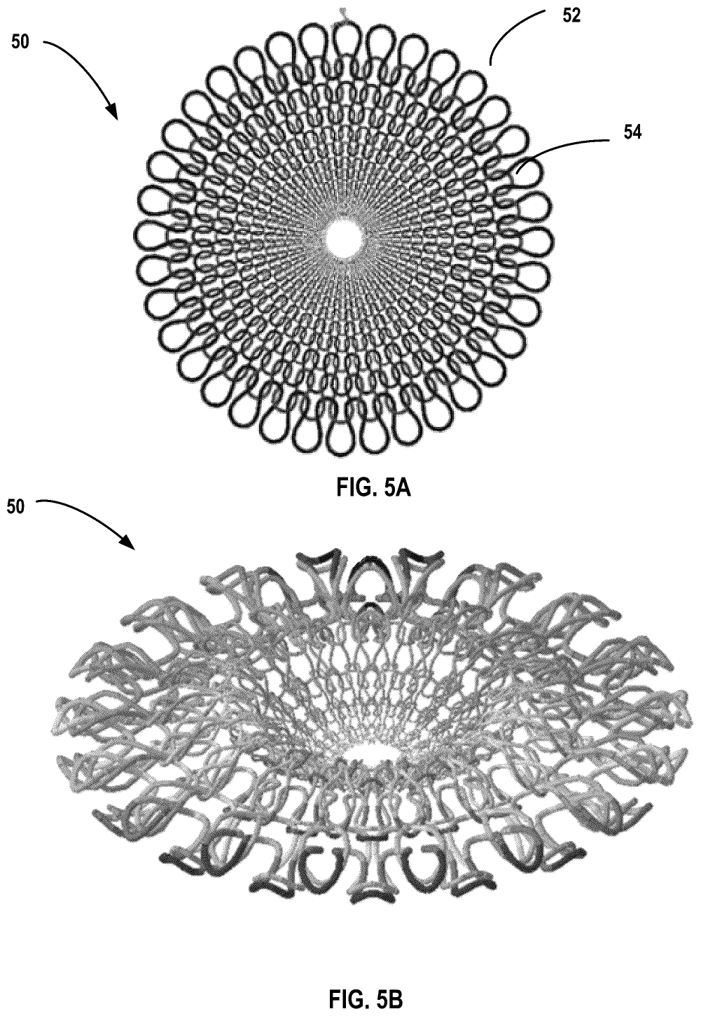

Referring now to FIG. 5A, a rib knit structure 50 comprised of knit and purl stitches is shown. The knit structure 50 is composed of a first knit material 52 and a second knit material 54 and each knit material has certain material characteristics shown below:

| | Thermal Coefficient | Elastic Modulus |
|---|---|---|
| First Knit Material 52 | −0.0005 | 2100 |
| Second Knit Material 54 | 0.0005 | 2100 |

FIG. 5B shows the knit structure 50 after a thermal load has been applied to the knit structure 50.

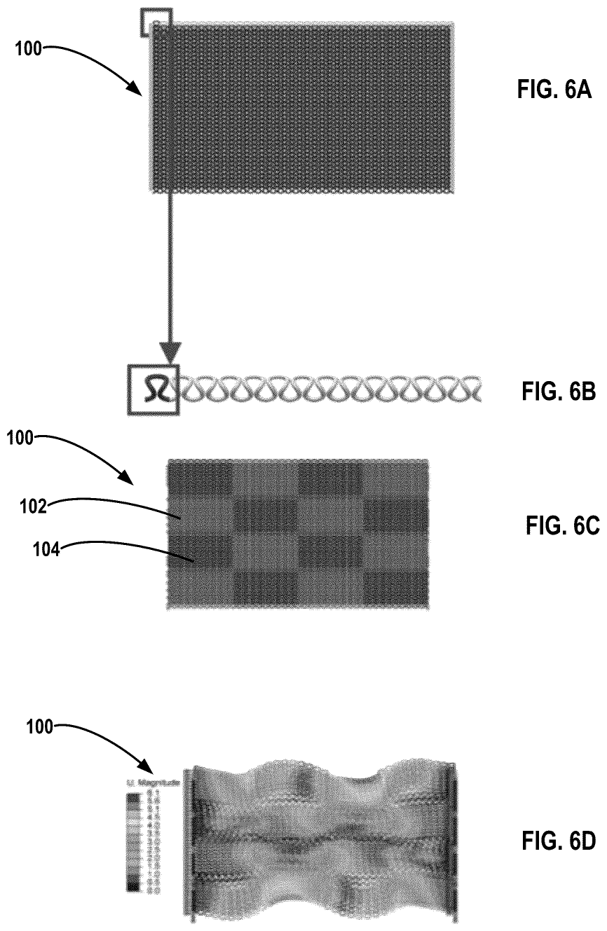

Referring now to FIGS. 6A-6D., these figures illustrate one example of a knit structure formed through knit morphing. As shown in FIG. 6A, a knit structure 100 is shown. The knit structure 100 is composed of a first knit material 102 and a second knit material 104 and each knit material has certain material characteristics shown below:

| | Thermal Coefficient | Elastic Modulus |
|---|---|---|
| First Knit Material 102 | −0.0005 | 2100 |
| Second Knit Material 104 | 0.0005 | 2100 |

As shown in FIG. 6C the knit material 102 and the knit material 104 can form a checkerboard pattern forming the knit structure 100. FIG. 6D shows a shape of the knit structure 100 after a thermal load is applied to the knit structure 100.

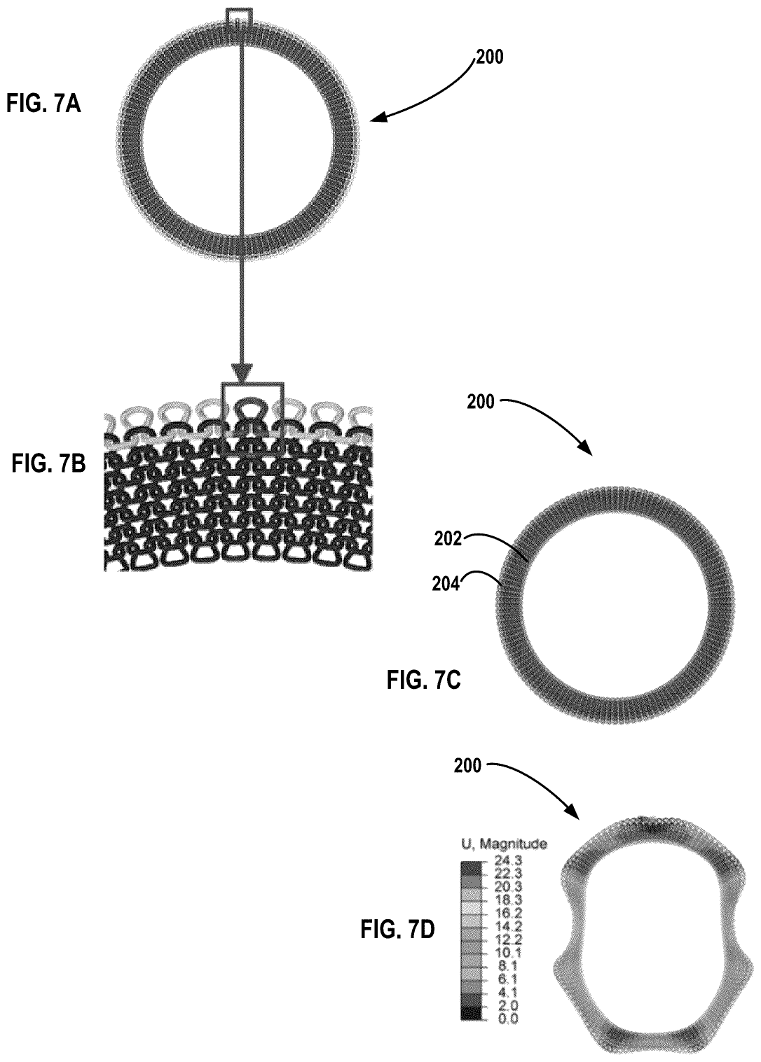

FIGS. 7A-D illustrate another example of a knit structure formed through knit morphing. As shown in FIG. 7A, a knit structure 200 is shown. The knit structure 200 is composed of a first knit material 202 and a second knit material 204 and each knit material has certain material characteristics shown below:

| | Thermal Coefficient | Elastic Modulus |
|---|---|---|
| First Knit Material 202 | −0.0005 | 2100 |
| Second Knit Material 204 | 0.0005 | 2100 |

FIG. 7C shows the locations of the different types of material included in the knit structure 200. And FIG. 7D shows a shape of the knit structure 200 after a thermal load is applied to the knit structure 200.

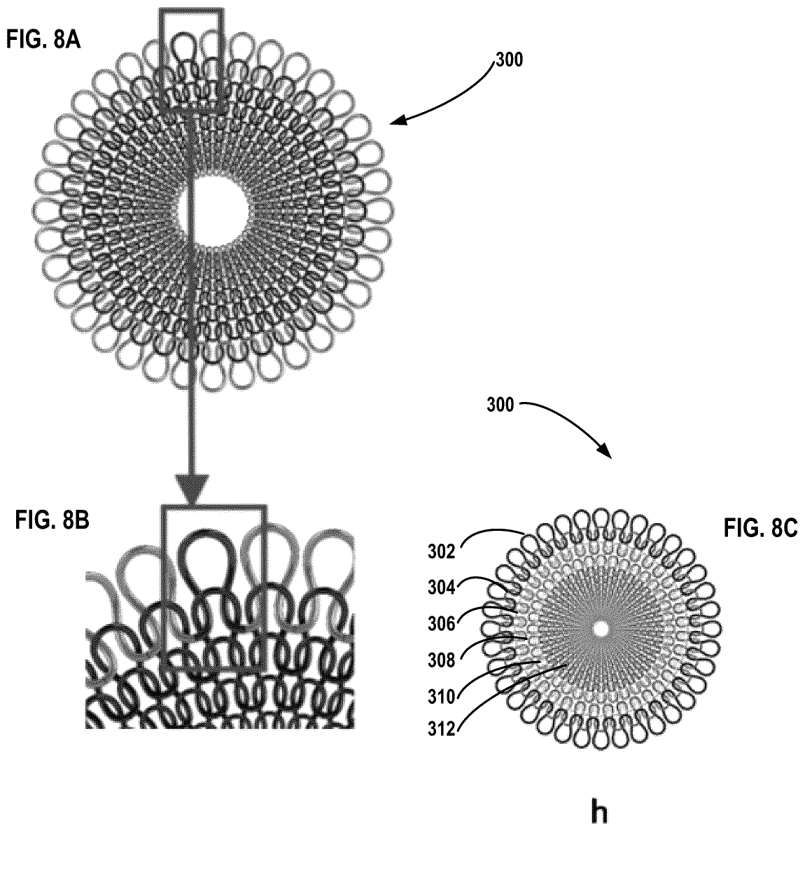

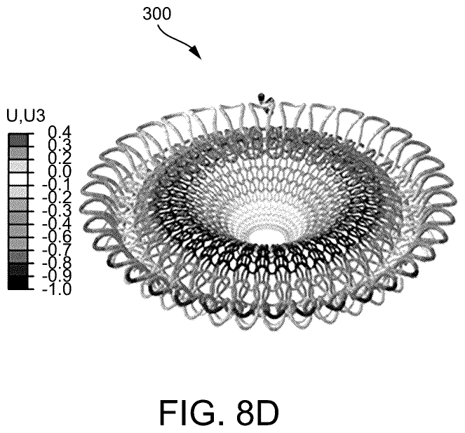

FIGS. 8A-8D illustrate another example of a knit structure formed through knit morphing. As shown in FIG. 8A, a knit structure 300 is shown. The knit structure 300 is composed of a first knit material 302, a second knit material 304, a third knit material 306, a fourth knit material 308, a fifth knit material 310, and a sixth knit material 312 and each knit material has certain material characteristics shown below:

| | Thermal Coefficient | Elastic Modulus |
|---|---|---|
| First Knit Material 202 | −0.0005 | 2100 |
| Second Knit Material 304 | −0.0003336 | 2100 |
| Third Knit Material 306 | 0 | 2100 |
| Fourth Knit Material 308 | 0.000166 | 2100 |
| Fifth Knit Material 310 | 0.0003336 | 2100 |
| Sixth Knit Material 312 | 0.0005 | 2100 |

FIG. 8C shows the locations of the locations of the different types of material included in the knit structure 300. And FIG. 8D shows a shape of the knit structure 300 after a thermal load is applied to the knit structure 300.

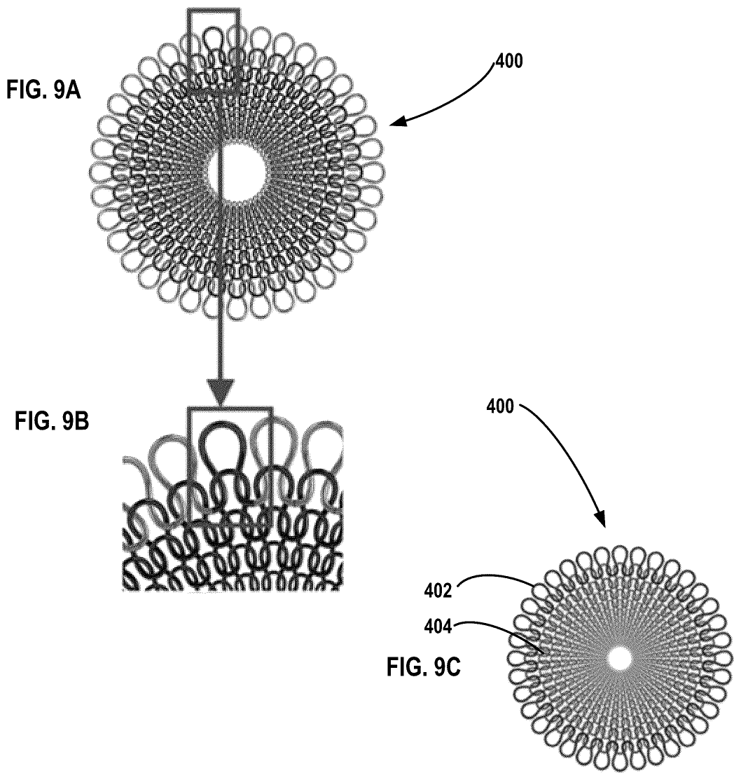

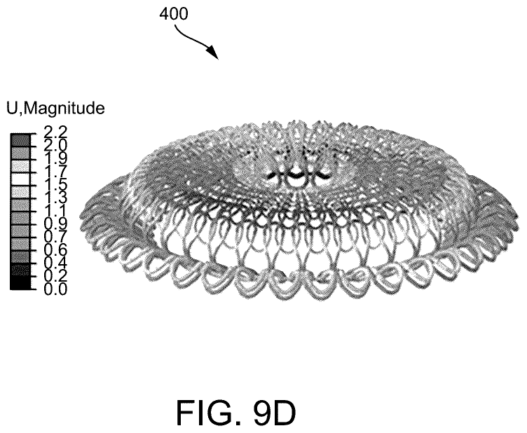

FIGS. 9A-9D illustrate another example of a knit structure formed through knit morphing.

As shown in FIG. 9A, a knit structure 400 is shown. The knit structure 400 is composed of a first knit material 402 and a second knit material 404 and each knit material has certain material characteristics shown below:

| | Thermal Coefficient | Elastic Modulus |
|---|---|---|
| First Knit Material 402 | −0.0005 | 2100 |
| Second Knit Material 404 | 0.0005 | 2100 |

FIG. 9C shows the locations of the different types of material included in the knit structure 400. And FIG. 9D shows a shape of the knit structure 400 after a thermal load is applied to the knit structure 400.

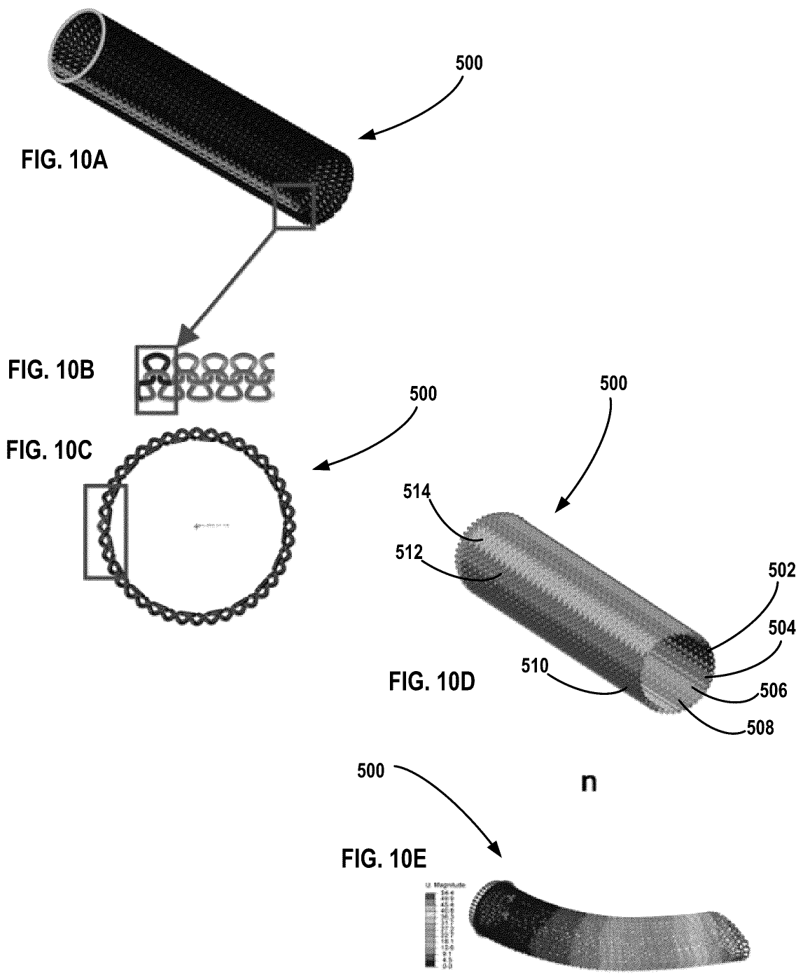

FIGS. 10A-10D illustrate another example of a knit structure formed through knit morphing. As shown in FIG. 10A, a knit structure 500 is shown. The knit structure 500 is composed of a first knit material 502, a second knit material 504, a third knit material 506, and fourth knit material 508, a fifth knit material 510, a sixth knit material 512, and a seventh knit material 514 and each knit material has certain material characteristics shown below:

| | Thermal Coefficient | Elastic Modulus |
|---|---|---|
| First Knit Material 502 | −0.0005 | 1100 |
| Second Knit Material 504 | −0.0003336 | 1600 |
| Third Knit Material 506 | −0.000166 | 2100 |
| Fourth Knit Material 508 | 0 | 2100 |
| Fifth Knit Material 510 | 0.0005 | 2100 |
| Sixth Knit Material 512 | 0.0003336 | 2100 |
| Seventh Knit Material 514 | 0.000166 | 2100 |

FIG. 10D shows the locations of the locations of the different types of material included in the knit structure 500. And FIG. 10E shows a shape of the knit structure 500 after a thermal load is applied to the knit structure 500.

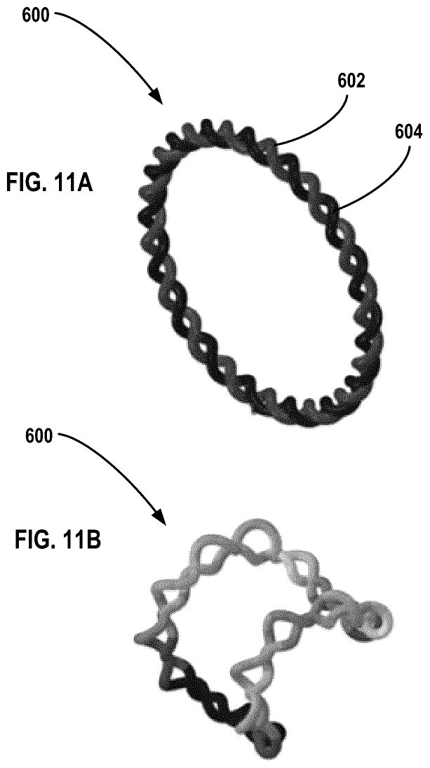

FIGS. 11A-11B illustrate another example of a knit structure formed through knit morphing. As shown in FIG. 11A, a knit structure 600 is shown. The knit structure 600 is composed of a first knit material 602 and a second knit material 604 wherein the knit materials 602, 604 are coiled and wherein each knit material has certain material characteristics shown below:

| | Thermal Coefficient | Elastic Modulus |
|---|---|---|
| First Knit Material 402 | −0.0005 | 2100 |
| Second Knit Material 404 | 0.0005 | 2100 |

FIG. 11B shows a shape of the knit structure 600 after a thermal load is applied to the knit structure 600.

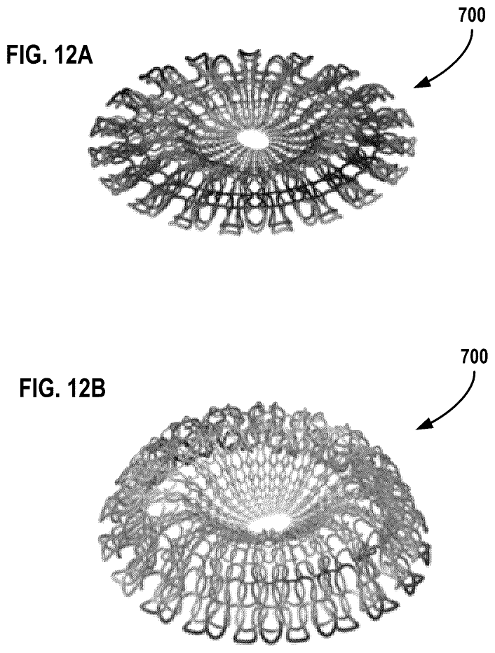

FIGS. 12A-12B illustrate another example of a knit structure formed through knit morphing. As described herein knitmorphing can be used to create movement of a knitmorph. As shown in FIG. 12A a first configuration of a knit structure 700 is shown and a second configuration of the knit structure 700 is shown in FIG. 12B. To obtain movement between the first configuration (FIG. 12A) and the second configuration (FIG. 12B) a thermal load can be applied to the knit structure 700. In some embodiments the thermal load can be from 293K to 696K. In some embodiments the thermal load applied to the knit structure 700 can be an alternating thermal load which can alternate between a positive thermal load and a negative thermal load or a greater thermal load and a lesser thermal load. In other embodiments movement can be created by applying the thermal load and removing the thermal load.

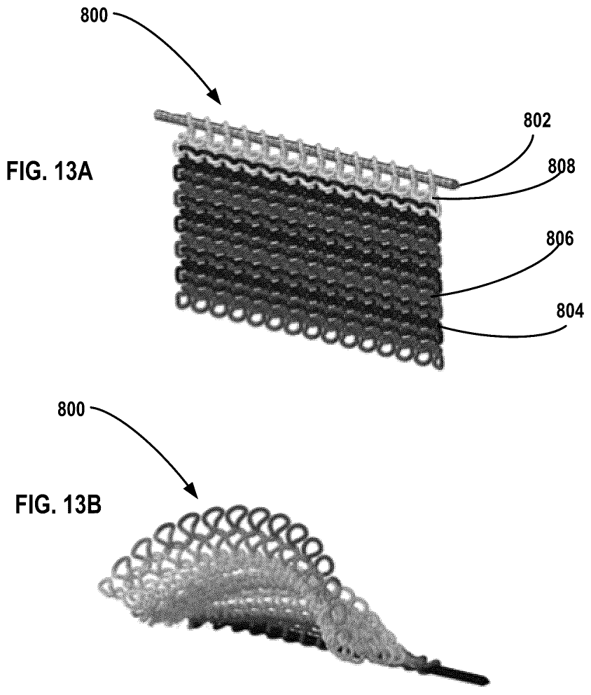

FIGS. 13A-13B illustrate another example of a knit structure formed through knit morphing. As shown in FIG. 13A, a knit structure 800 is shown on a knitting needle 802. The knit structure 800 is composed of a first knit material 802, a second knit material 804, and a third knit material 808. Each knit material 804, 806, 808 has certain material characteristics shown below:

| | Thermal Coefficient | Elastic Modulus |
|---|---|---|
| First Knit Material 804 | −0.0005 | 2100 |
| Second Knit Material 806 | 0.0005 | 2100 |
| Third Knit Material 808 | 0 | 2100 |

FIG. 13B shows a shape of the knit structure 800 after a thermal load is applied to the knit structure 800.

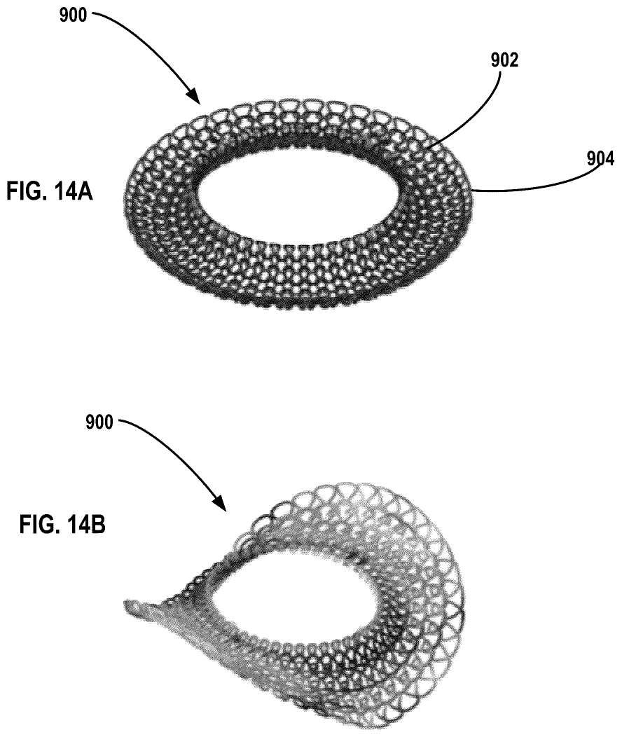

FIGS. 14A-14B illustrate another example of a knit structure formed through knit morphing. As shown in FIG. 14A, a knit structure 900 is shown having a half toroidal shape. The knit structure 900 is composed of a first knit material 902, and a second knit material 904. Each knit material 902, 904 has certain material characteristics shown below:

| | Thermal Coefficient | Elastic Modulus |
|---|---|---|
| First Knit Material 902 | −0.0005 | 2100 |
| Second Knit Material 904 | 0.0005 | 2100 |

FIG. 14B shows a shape of the knit structure 900 after a thermal load is applied to the knit structure 900.

As shown and described in the examples above, a method of manufacturing three-dimensional structures using knitmorphing can include obtaining a first yarn material which can have certain material properties. Some of the material properties are shown in the charts above. The materials can have differing thermal coefficients and elastic moduli. The first yarn material 12 can be comprised of natural fibers including for example wool, cashmere, alpaca, cotton, linen, or bamboo. In other embodiments, the first yarn material 12 can be a synthetic material and can be comprised of fibers including rayon, acrylic, nylon, or polymer. As described above, in some embodiments, the first yarn material can comprise twisted and coiled nylon fibers. The method for manufacturing a three-dimensional structure using knit morphing can further include obtaining a second yarn material 14. The second yarn material 14 can be the same as the first yarn material 12 or different than the first yarn material 12 and may have the same material properties as the first yarn material 12 or different material properties than the first yarn material 12.

The method then includes knitting the first yarn material 12 and the second yarn material 14 together to form a knit structure having a first shape. The first yarn material and the second yarn material can be knit together using any known methods to form any desired shape. For example, and as shown above, the first and second yarn materials can be knit together using plain and/or purl stitches. In still other examples, the first yarn material and the second yarn material can be braided or coiled together rather than, or in addition to, being stitched together. Once the desired first shape has been attained, the method can continue by applying a thermal load to at least one of the first yarn material or the second yarn material. In some embodiments the thermal load can be thermal load can be from 293K to 696K. As shown and described above, the thermal load can cause the first yarn material and/or the second yarn material to deform. The deformation of the first yarn material and/or second yarn material can cause the first shape to deform and thereby form a second shape.

In some examples, after the thermal load has been applied to the knit structure, a hardening agent such as a resin may be applied to the knit structure to permanently harden the knit structure in the second shape. Such a method may be advantageous for production of large or difficult to transport shapes. For example, a knit structure can be knit at a first site and then transported to a second site where a thermal load and hardening agent can be applied. Such a manufacturing method can also be useful for manufacturing of large structures that require heavy logistical planning for transportation such as wind turbine blades, or to an industry requiring minimal storage consumption but rapid manufacturing, such as satellite or space exploration. In this dieless forming method, the knit structure can be pre-manufactured using a thermoplastic resin and packaged with ease of transportation or storage in mind.

In other examples the method for manufacturing a three-dimensional shape can further include removing the thermal load to thereby return the knitted structure to the first shape. Or in still other embodiments, the method for manufacturing a three-dimensional shape can further include applying a different thermal load than the first load to thereby form the knit structure into a different third shape. Such applications or removal of thermal loads can create a movable structure and may create a structure capable of locomotion. As shown for example in FIGS. 12A-12B, movement similar to a jellyfish can be created using the knit structure and application of different thermal loads. Alternating between applying a thermal load and removing the thermal load or applying a different thermal load can also find application in robotic systems and actuators where applications involve repeated/cyclic motion such as grasping objects, locomotion and cargo payload carriage and delivery. Individual fibers or yarns can be actuated within a large network of fibers or yarns for localized actuation. In some cases, the actuation is bought about by heating of fibers to different degrees. In some embodiments, this can be done by integrating a heating element or heating wire into the fibers or yarns and/or embedding or in braids.

As shown and described in the examples above, knitmorphing can produce a knit structure 10. The knit structure can include a first yarn material 12 which has first material properties and a second yarn material 14 which has second material properties. As disclosed above the material properties of the first and second yarn can be the same or different from each other. Further, as disclosed above the knit structure can be composed of any number of different or the same knit materials. As shown in FIG. 1, the first knit material 12 and the second knit material 14 can be knit together to form a first shape. A thermal load can then be applied to the first shape to deform the knit structure and form it into a second shape. Any combination of knit stitches and patterns may be used to form the knit structure including plain stitches and purl stitches. In other embodiments, the first yarn material and the second yarn material may be braided and/or coiled together.

As described above, the knit structure may also include a hardening agent such as a resin which may permanently lock the knit structure in the second shape formation. Additionally, as described above, one or more of the yarn materials that make up the knit structure may include a heating element or heating wire which can be used to instigate the thermal load to the particular knit material.

Knitmorphing as described herein may be applicable to a number of different designs and industries because of its ability to form various complex shapes. For example, the shapes and products that may be formed through knitmorphing can include an oil pan bottom, car fenders, engine casings. In addition, development of prototypes can be accomplished bypassing the need to create complex molds. Morphing fabrics as described herein can be the cornerstone for dieless forming of composite suitable for personalized items and rapid prototyping. This reduction of initial investment in capital equipment and tooling with low cycle time could significantly reduce cost per unit stiffness to be at par with steels. Moreover, since the process can be fully automated, it makes it suitable for industrial applications. This would bring down the barriers obstructing the widespread adoption of composites in different manufacturing sectors such as the automotive industry.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the disclosure and are thus within the spirit and scope of the present disclosure. From the above description and drawings, it will be understood by those of ordinary skill in the art that the particular embodiments shown and described are for purposes of illustrations only and are not intended to limit the scope of the present disclosure. References to details of particular embodiments are not intended to limit the scope of the disclosure.

What is claimed is:

1. A method of manufacturing a three-dimensional structure comprising:
obtaining a first yarn material, the first yarn material having first material properties;
obtaining a second yarn material, the second yarn material having second material properties;
knitting the first yarn material and the second yarn material together to form a knit structure having a first shape; and
applying a thermal load to at least one of the first yarn material or the second yarn material to thereby deform the first yarn material and/or the second yarn material and thereby form a second shape.

2. The method of manufacturing a three-dimensional structure of claim 1, wherein the first yarn material and the second yarn material are knitted together using purl stitches.

3. The method of manufacturing a three-dimensional structure of claim 1, wherein the first yarn material and the second yarn material are knitted together using plain stitches.

4. The method of manufacturing a three-dimensional structure of claim 1, wherein the first yarn material and the second yarn material are braided together.

5. The method of manufacturing a three-dimensional structure of claim 1, wherein the thermal load causes the first yarn material to expand.

6. The method of manufacturing a three-dimensional structure of claim 1, wherein the thermal load causes the first yarn material to contract.

7. The method of manufacturing a three-dimensional structure of claim 1, wherein the first yarn material is natural material.

8. The method of manufacturing a three-dimensional structure of claim 1, wherein the first yarn material comprises one of wool, cashmere, alpaca, cotton, linen, or bamboo.

9. The method of manufacturing a three-dimensional structure of claim 1, wherein the first yarn material is a synthetic material.

10. The method of manufacturing a three-dimensional structure of claim 1, wherein the first yarn material comprises one of rayon, acrylic, nylon, or polymer.

11. The method of manufacturing a three-dimensional structure of claim 1, wherein the first yarn material comprises twisted and coiled nylon fibers.

12. The method of manufacturing a three-dimensional structure further comprising:
applying a resin to the three-dimensional shape to thereby lock the knitted structure in the second shape.

13. The method of manufacturing a three-dimensional structure of claim 1, further comprising:
removing the thermal load to thereby return the knitted structure to the first shape.

14. A knit structure comprising:
a first yarn material, the first yarn material having first material properties;
a second yarn material, the second yarn material having second material properties;
wherein the first yarn material and the second yarn material are knit together forming a first shape; and
wherein when a thermal load is applied to at least one of the first yarn material or the second yarn material the first yarn material and/or the second yarn material deform thereby form a second shape.

15. The knit structure of claim 14, wherein the first yarn material and the second yarn material are knitted together using purl stitches.

16. The knit structure of claim 14, wherein the first yarn material and the second yarn material are knitted together using plain stitches.

17. The knit structure of claim 14, wherein the first yarn material and the second yarn material are braided together.

18. The knit structure of claim 14, wherein a resin is applied to the knit structure.

19. The knit structure of claim 14, wherein when the thermal load is removed the knit structure returns to the first shape.

20. The knit structure of claim 14, wherein the first yarn material includes a heating wire integrated with the first yarn material.
